(19) United States
(12) Patent Application Publication
(10) Pub. No.: US 2005/0065621 A1
(43) Pub. Date: Mar. 24, 2005

(54) Methods of designing optimal linear controllers

(76) Inventors: Danyang Liu, Edmonton (CA); Wuyang Liu, Nanchang (CN)

Correspondence Address: Danyang Liu;#108, 10615-111 Street, Edmonton, AB, T5H 3G1, CA

(21) Appl. No.: 10/981,500

(22) Filed: Nov. 5, 2004

Related U.S. Application Data
(63) Continuation-in-part of application No. 10/069,364, filed on Feb. 25, 2002.

(30) Foreign Application Priority Data
Jun. 20, 2000 (CA) 2,311,268

(51) Int. Cl. G05B 13/02

(52) U.S. Cl. 700/37

(57) ABSTRACT

Methods of designing optimal discrete-time PID (proportional-integral-derivative) controllers and linear controllers are disclosed. The optimal values of the tuning parameters in a PID controller or a linear controller are determined by minimizing the maximum of absolute values of all poles of the discrete-time closed-loop transfer function from the set-point to the process variable subject to, if any, user-specified constraints on one or more of the tuning parameters.

### CROSS-REFERENCE TO RELATED APPLICATIONS

Domestic priority data: This application is a 371 of PCT/IB01/01002 Jun. 7, 2001

Foreign applications: Jun. 20, 2000 [CA] Canada 2,311,268

STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable

### BACKGROUND OF THE INVENTION

1. Technical Field of the Invention

This invention relates to the design of optimal linear controllers and PID controllers.

2. Description of Related Art

FIG. 1 shows a process 1 controlled by a PID (proportional-integral-derivative) or a linear controller 2. The PID controller or linear controller 2 means a linear system, usually implemented in a computer or as an electronic circuit, that receives the process variable signal y(k) and set-point signal r(k) as its inputs and calculates the controller output signal u(k) according to a PID control equation or a linear control equation, where k is the integer discrete time variable, and u(k) may or may not subject to further user-specified constraints. For a multiple-input and multiple-output (MIMO) process, the process variable y(k) is an n-dimensional vector with each of its components being a scalar process variable and the controller output u(k) is an m-dimensional vector variable with each of its components being a scalar controller output, where n and m are positive integers. It is desired that the performance of the controller should be such that, after the controller output signal u(k) is sent to the process 1, the process variable y(k) should approach the set-point r(k) quickly and smoothly as the time variable k increases, where r(k) is an n-dimensional set-point signal (also known as the reference signal or the command signal, etc.)

There are many types of PID controllers, depending on the use of different types of PID control equations. All types of PID controllers can be viewed as special cases of linear controllers. By definition, a discrete-time linear controller means a controller whose output u(k) is a linear function of past controller outputs, current and past process variables, and current and past set-point variables, as shown in FIG. 2. This definition is well known to any person skilled in the art (see, e.g., FIG. 2.4 and Assumption 2.3 on page 29 of the cited book “Linear Controller Design” authored by Boyd and Barratt and published by Prentice Hall in 1991).

Once the structure of its control equation is properly selected, the performance of a PID controller or a linear controller depends mainly on the choice of coefficients in the control equation. The adjustable numbers in the coefficients are called tuning parameters (also known as tuning coefficients, tuning gains or tuning constants, etc.)

How to properly choose the values of the tuning parameters for a PID controller is a problem that has attracted a lot of studies ever since PID controllers became widely used in industry in the early 1940s. The Ziegler-Nichols tuning methods developed by Ziegler and Nichols in 1942 (see the Ziegler and Nichols reference), either in their original form or in some modification, are still widely used in industry. Other model-based optimization methods choose the tuning parameters by minimizing some well-known control performance index such as the integrated absolute errors (IAE), the integrated squared errors (ISE), the integrated time absolute error (ITAE), etc. (see U.S. Pat. No. 5,453,925). However, practice shows that all these methods often lead to the undesired oscillatory control results.

Many tuning methods are based on the continuous-time transfer function analysis (see, for example, the cited U.S. Pat. No. 6,434,436 B1 to Adamy et al., U.S. Pat. No. 5,866,861 to Rajamani et al., U.S. Pat. No. 4,539,633 to Shigemasa et al., U.S. Pat. No. 4,563,734 to Mori et al., the cited research papers by Celentano et al., Zhuang et al., Dorf et al., Katebi et al., and Saeki et al., and the cited book “Linear Controller Design” authored by Boyd et al.). Therefore these methods cannot guarantee the optimal performance of controllers in the discrete-time domain. This is a real problem since nowadays almost all PID or linear controllers are implemented in digital computers and therefore they are working in the discrete-time domain, not the continuous-time domain.

Other tuning methods in discrete-time domain cannot guarantee that the largest absolute value of all the poles of the closed-loop transfer function is minimized. Therefore they cannot guarantee the optimal performance of the controller (see, e.g., the cited U.S. Pat. No. 5,680,304 to Wang et al. and the cited research paper by Yamamoto et al., etc.).

### BRIEF SUMMARY OF THE INVENTION

This invention chooses the tuning parameters in a PID controller or a linear controller by minimizing the maximum of absolute values of all poles of the discrete-time closed-loop transfer function from said set-point r(k) to said process variable y(k) subject to, if any, user-specified constraints on one or more of the tuning parameters. When the tuning parameters are chosen this way, the PID controller or linear controller can guarantee that the process variable y(k) tracks the set-point r(k) smoothly and quickly as time k increases.

### BRIEF DESCRIPTION OF THE DRAWINGS

FIG. 1 shows a process 1 controlled by a PID controller or a linear controller 2. The PID controller or linear controller is in discrete-time form.

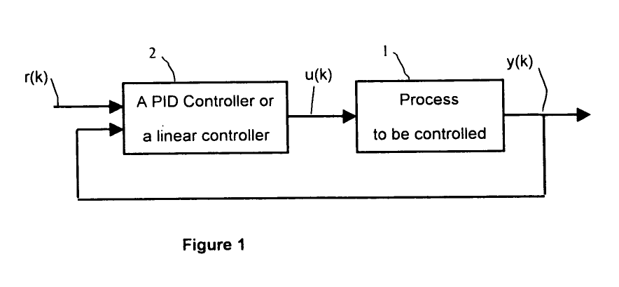

FIG. 2 shows a PID or a linear controller. By definition, the controller output u(k) of a linear controller is a linear function of u(k−1), u(k−2), . . . , u(k−a), y(k), y(k−1), . . . , y(k−b), r(k), r(k−1), r(k−2), . . . r(k−c), wherein a>0, b and c are integers (This definition is well known to any person skilled in the art and is given in FIG. 2.4 and Assumption 2.3 on page 29 of the cited book “Linear Controller Design” authored by Boyd et al.)

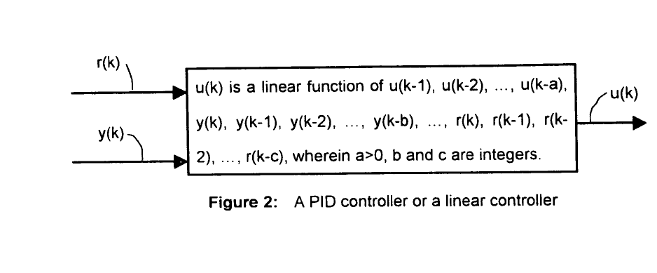

### DETAILED DESCRIPTION OF THE INVENTION

From now on it is always assumed that:
(1) The open-loop discrete-time transfer function of the process 1 is known, suppose it is G, and
(2) The structure of the control equation of the PID controller or the linear controller has already been properly chosen and is already in discrete-time form, suppose it is u(k)=G₁r(k)−G₂y(k), where G₁ and G₂ are two discrete-time transfer functions with tuning parameters.

It is then easy for anyone skilled in the art to find the discrete-time closed-loop transfer function from the set-point r(k) to the process variable y(k), which is (I+GG₂)⁻¹GG₁. This invention chooses the best values for the tuning parameters in a PID controller or a linear controller in such a way that the largest absolute value of all poles of said discrete-time closed-loop transfer function from said set-point r(k) to said process variable y(k) is minimized subject to, if any, user-specified constraints on one or more of the tuning parameters. This choice guarantees that the process variable y(k) tracks the set-point r(k) smoothly and quickly as time k increases.

The above description contains a minimax optimization problem. The general minimax problem has been very well studied and many successful numerical methods and algorithms have been developed, see, e.g., the cited publications by Charalambous et al., Conn et al., Conn, Pillo, Gigola et al., Polyak, Polak, Polak et al., Vardi, Zang, Murray et al., Kaufman et al., Reemsten, Zhou et al., and Laskari et al. Successful commercial computer programs such as the “Optimization Toolbox for use with Matlab” developed by The MathWorks Inc. can directly be used to solve the minimax problem as formulated in this invention without any difficulty (see the cited book “Optimization Toolbox User's Guide” authored by Coleman et al. and published by The MathWorks Inc.). The “Optimization Toolbox” and Matlab have been well known among people skilled in the art. It is easy for anyone skilled in the art to solve the minimax problem directly using the “Optimization Toolbox”, the methods in the cited publications mentioned above, or any other method.

1. A method for determining the optimal tuning parameters in a linear controller, wherein
1) said controller receives an n-dimensional process variable signal y(k) from a process and an n-dimensional set-point signal r(k), calculates an m-dimensional controller output u(k) according to a linear control equation, and sends said u(k) to said process, where k is the integer discrete time variable and n and m are positive integers,
2) said tuning parameters are the adjustable numbers in the coefficients in said linear control equation that are to be determined, and
3) said method finds the optimal values for said tuning parameters by minimizing the maximum of absolute values of all poles of the discrete-time closed-loop transfer function from said set-point r(k) to said process variable y(k);

2. A method as in claim 1, wherein said minimization of the maximum of absolute values of all poles of said discrete-time closed-loop transfer function is subject to user-specified constraints placed on one or more of said tuning parameters;

3. A method as in claim 1, wherein said controller output u(k)=u(k−1)+K₁*r(k)*T+K₁*a(k,1)+K₂*a(k,2k )+ . . . +Kₚ*a(k,p), wherein k is the discrete time variable, * is the multiplication operator, T is the sampling period, p is a positive integer, the m by n matrices K₁, K₂, . . . , and Kₚ are tuning parameters, a(k,1)=[−y(k)]*T, and a(k, p)=[a(k,p−1)−a(k−1,p−1)]/T for p>or =2;

4. A method as in claim 2, wherein said controller output u(k)=u(k−1)+K₁*r(k)*T+K₁*a(k,1)+K₂*a(k,2)+ . . . +Kₚ*a(k,p), wherein k is the discrete time variable, * is the multiplication operator, T is the sampling period, p is a positive integer, the m by n matrices K₁, K₂, . . . , and Kₚ are tuning parameters, a(k,1)=[−y(k)]*T, and a(k, p)=[a(k,p−1)−a(k−1,p−1)]/T for p>or =2;

5. A method as in claim 1, wherein said linear controller is a PID (proportional-integral-derivative) controller;

6. A method as in claim 2, wherein said linear controller is a PID controller;

7. A method as in claim 3, wherein said controller output is changed to u(k)=u(k−1)+K₁*r^{f}(k)*T+K₁*a^{f}(k,1)+K₂*a^{f}(k,2)+ . . . +Kₚ*a^{f}(k,p), where r^{f}(k), a^{f}(k,1), a^{f}(k,2), . . . , and a^{f}(k,p) are, respectively, the filtered signals of r(k), a(k,1), a(k,2), . . . , and a(k,p);

8. A method as in claim 4, wherein said controller output is changed to u(k)=u(k−1)+K₁*r^{f}(k)*T+K₁*a^{f}(k,1)+K₂*a^{f}(k,2)+ . . . +Kₚ*a^{f}(k,p), where r^{f}(k), a^{f}(k,1), a^{f}(k,2), . . . , and a^{f}(k,p) are, respectively, the filtered signals of r(k), a(k,1), a(k,2), . . . , and a(k,p);

9. A linear controller as in claim 1 with its tuning parameters determined using the method in claim 1;

10. A linear controller as in claim 2 with its tuning parameters determined using the method in claim 2;

11. A linear controller as in claim 3 with its tuning parameters determined using the method in claim 3;

12. A linear controller as in claim 4 with its tuning parameters determined using the method in claim 4;

13. A PID controller as in claim 5 with its tuning parameters determined using the method in claim 5;

14. A PID controller as in claim 6 with its tuning parameters determined using the method in claim 6;

15. A linear controller as in claim 7 with its tuning parameters determined using the method in claim 7;

16. A linear controller as in claim 8 with its tuning parameters determined using the method in claim 8;

17. A linear controller as in claim 9 with its output being subjected to user-specified constraints;

18. A linear controller as in claim 10 with its output being subjected to user-specified constraints;

19. A linear controller as in claim 15 with its output being subjected to user-specified constraints;

20. A linear controller as in claim 8 with its output being subjected to user-specified constraints;
